(19) United States
(12) Patent Application Publication
(10) Pub. No.: US 2011/0114417 A1
(43) Pub. Date: May 19, 2011

(54) LATTICE SUPPORT STRUCTURE WITH EVACUATION MEANS

(75) Inventors: Kamal Daas, Bergschenhoek (NL); Doron Livnat, Rotterdam (NL)

(73) Assignee: PRODELTA INVESTMENTS B.V., Rotterdam (NL)

(21) Appl. No.: 13/002,895

(22) PCT Filed: Jul. 10, 2009
(86) PCT No.: PCT/EP2009/005018

§ 371 Date: Jan. 6, 2011

(30) Foreign Application Priority Data
Jul. 10, 2008 (DE) 20 2008 009 282.5

(51) Int. Cl. E06C 1/39; E06C 1/38

(52) U.S. Cl. 182/115; 182/152

(57) ABSTRACT

The present invention relates to a lattice support structure which includes interconnected lattice bars, wherein the lattice bars are connected with each other such that the lattice support structure can be folded in and out, wherein evacuation means for evacuating persons are arranged on or in the lattice support structure.

The present invention relates to a lattice support structure which includes interconnected lattice bars, wherein the lattice bars are connected with each other such that the lattice support structure can be folded in and out.

Such lattice support structures are known from the prior art. They can be used for example as support structures which have the advantage that in the condition folded out, i.e. in their operating position, the represent a loadable and mechanically stable structure. Another advantage of these lattice support structures consists in that in the condition folded in they require comparatively little space and therefore can be stored and transported quite easily.

Lattice support structures known from the prior art consist, for example, of lattice bars extending in longitudinal direction of the lattice support structure, which are connected with each other by connecting lattice bars, wherein the connecting lattice bars are connected with the longitudinally extending lattice bars such that the distance of the lattice bars extending in longitudinal direction of the lattice support structure can be reduced when the lattice support structure is folded in, and can be increased when the lattice support structure is folded out.

It is the object underlying the present invention to develop a lattice support structure as mentioned above such that its possibilities of application are expanded.

This object is solved by a lattice support structure with the features of claim 1. It is provided that evacuation means for evacuating persons are arranged on or in the lattice support structure.

Thus, the present invention is based on the knowledge that the lattice support structure can be used for example for evacuating persons from a burning building or the like. These evacuation means can be designed for example as a ladder or the like.

The lattice support structure can for example be firmly mounted on a building or the like and be folded out if necessary, i.e. in a case of emergency, in order to provide for the evacuation of persons. When the lattice support structure is not required for such purpose, it can be arranged on the house in the condition folded in and require comparatively little space in this condition.

It is likewise conceivable that the lattice support structure is not firmly associated to a building or the like, but is moved to this place in a case of emergency and is erected and folded out there. It can be provided that the lattice support structure consists of a plurality of lattice support structure segments, which can be joined together in longitudinal direction, in order to obtain a sufficient height of the lattice support structure. The connection of the individual segments can be obtained for example by a bolt connection or the like.

The at least one ladder can be arranged on at least one of the longitudinally extending lattice bars of the lattice support structure.

It is conceivable that one ladder each is associated to each of the longitudinally extending lattice bars of the lattice support structure. However, this is not absolutely necessary.

In a further aspect of the invention it is provided that the evacuation means comprise at least one ladder and at least one fall arrester associated to the ladder, in particular a number of rods, which at least partly surround the space taken by a person standing on the ladder. This fall arrester can for example be pivotally mounted on the lattice support structure or also on the ladder or on the other evacuation means and be swivelled out if necessary, so that said fall arrester is realized.

The evacuation means need not necessarily be formed by ladders. In principle, any other evacuation means can be used, such as rods, scaffolds, guard rails etc.

In a further aspect of the invention it is provided that the evacuation means include at least one walkway, which in at least one position protrudes from the lattice support structure or connects different positions of the lattice support structure with each other.

In the first case, the walkway can serve to enable persons to get for example from a building to be evacuated to the lattice support structure and hence also to the further evacuation means provided on the same, for example to ladders.

In the second alternative it can be provided that the walkway provides for getting from one position of the lattice support structure to another position of the lattice support structure. In this case, the walkways can for example extend along the outside of the lattice support structure or also through the interior of the lattice support structure. In this case, they can serve to uniformly distribute the persons to be evacuated over the evacuation means, for example over several ladders of the lattice support structure.

It is particularly advantageous when the walkway in at least one position extends vertically or also obliquely from or in the lattice support structure, so that the persons to be evacuated can easily get to the lattice support structure or can run from one position of the lattice support structure to another position.

Furthermore, it can be provided that in at least one position of the lattice support structure the walkway extends parallel to the lattice support structure. In this case, the walkway requires particularly little space, as it rests against the lattice support structure for example for transport or storage purposes.

The connecting lattice bars can rest against the outer surface or outer surfaces of the lattice support structure. The lattice bars extending in longitudinal direction of the lattice support structure can form the outer edges of the lattice support structure. The lattice support structure can be designed with a rectangular, square, triangular or polygonal cross-section or the like.

In a further aspect of the invention it is provided that the lattice support structure includes a structure of longitudinally extending lattice bars and connecting lattice bars, which is repeated in longitudinal direction.

At least part of the connecting lattice bars can be formed by connecting struts, which in the condition of the lattice support structure folded out extend from one of the lattice bars extending in longitudinal direction of the lattice support structure to the other.

It can be provided that the connecting struts have at least one joint, by means of which they can be adjusted between a condition folded in and a condition folded out.

The connecting struts spaced in longitudinal direction of the lattice support structure can be connected with each other for example via rods or the like.

There can be provided locking means for fixing the connecting lattice bars in at least one position. In this way, it is ensured that in the condition folded out the lattice support structure remains in this position and does not collapse unintentionally.

Furthermore, it can be provided that means are provided which act on at least two of the connecting and/or longitudinally extending lattice bars such that the distance of the lattice bars to each other can be increased or reduced, whereby the lattice support structure is folded in or out.

Finally, it can be provided that the lattice support structure includes at least two support structure segments which are designed such that they are telescopable with respect to each other. In this way, it is possible to particularly easily obtain the desired height of the entire support structure construction. Two or more than two support structure segments can be provided, which are telescopable with respect to each other. It is conceivable to unfold the support structure segments after telescoping out and then connect the same with those support structure segments from which they were telescoped out. In this way, any desired height of the lattice support structure can be obtained in principle.

The invention furthermore relates to a lattice support structure with expandable structures, in particular a lattice support structure according to any of claims 1 to 18, wherein the lattice support structure includes pivotally arranged lattice bars, wherein the pivotable connection is designed such that one of the pivotally connected parts includes a projection and that the other one of the pivotally connected parts includes a groove defined by walls on three sides, in which the projection of the other part is pivotally accommodated. The groove base thus serves as boundary, so that swivelling the lattice bar only is possible until one of said parts comes to rest on the groove base. In this position the lattice bar thus is blocked and/or further swivelling is not possible. Such a pivotable connection can be provided where two segments of a lattice bar are pivotally connected with each other and/or where a lattice bar is articulated to another part of the lattice support structure.

The lattice bar can include the projection at its one end region and said groove at its other end region. In this way, it is possible to connect several lattice bars with each other and/or to provide lattice bars of different lengths. In principle, it is also conceivable to design both ends of the lattice bar with grooves or with said projections.

Particularly advantageously, a braking and/or a fixing means is provided, which fixes the lattice bars in a certain swivel position. For example, it can be a drum, disk or shoe brake. The brake can be actuated e.g. hydraulically or mechanically. The brake can include brake shoes which have two projections which upon actuation of the brake simultaneously make contact with the respectively adjacent part, for example with said projection, and thus provide an optimum braking effect.

Further details and advantages of the invention will be explained in detail with reference to an embodiment illustrated in the drawing, in which:

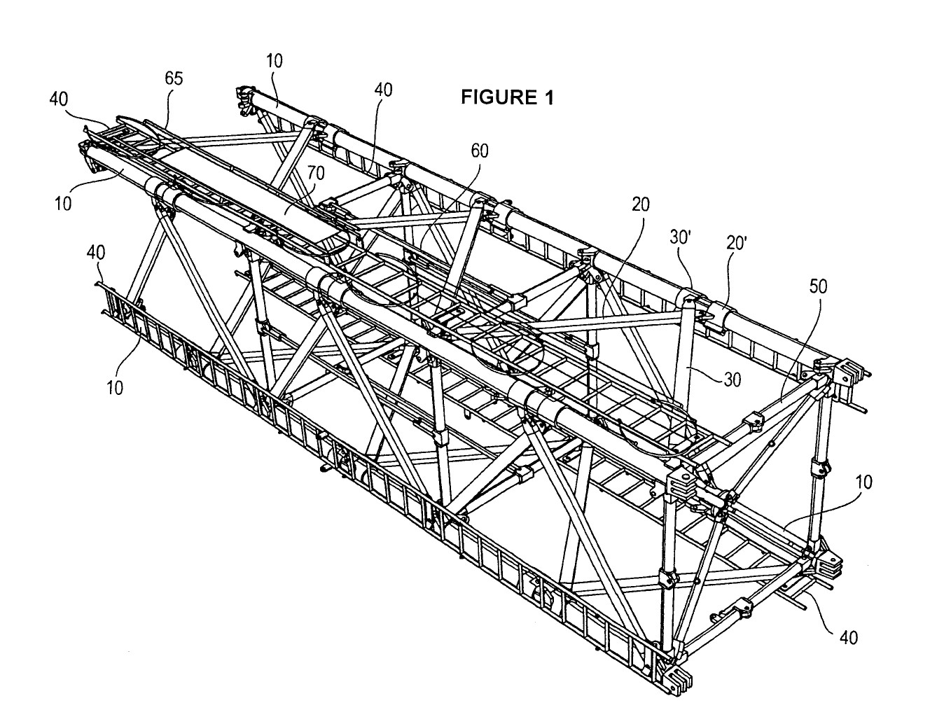

FIG. 1: shows a perspective representation of the lattice support structure of the invention in the condition folded out,

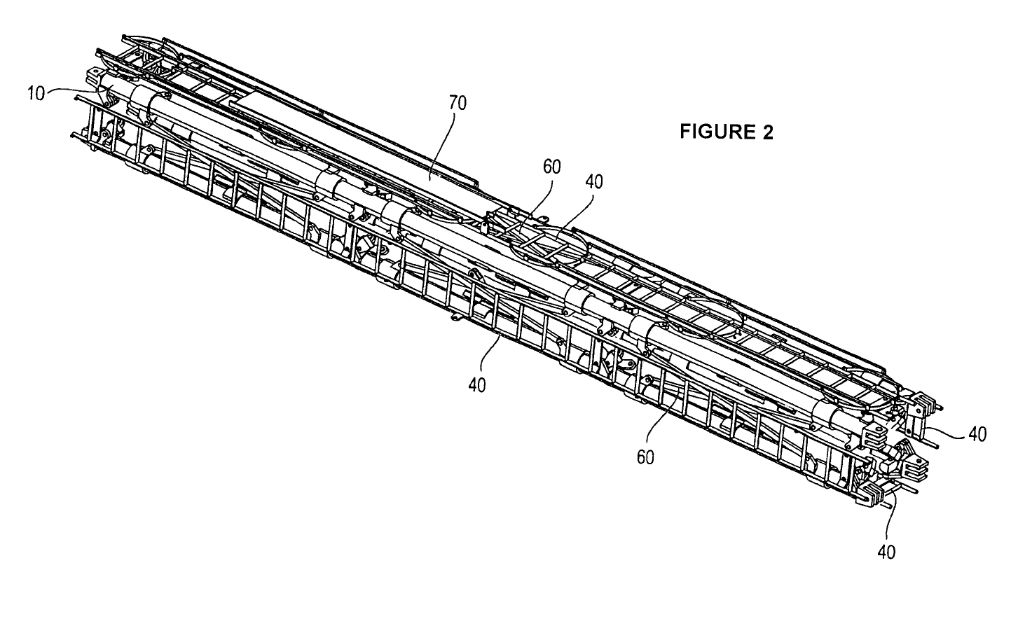

FIG. 2: shows a perspective representation of the lattice support structure of the invention in the condition folded in, and

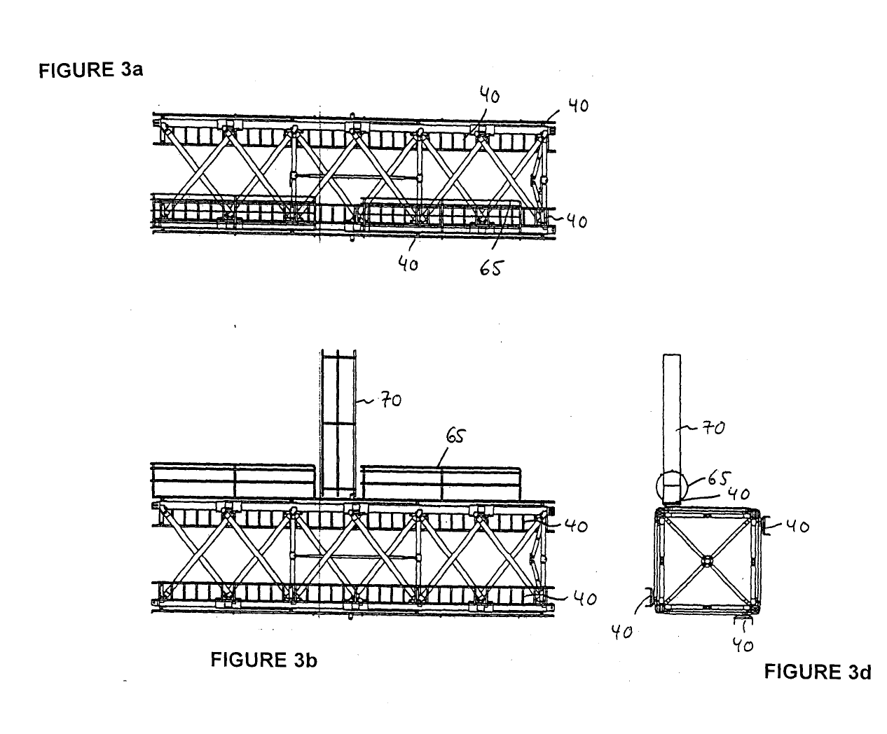

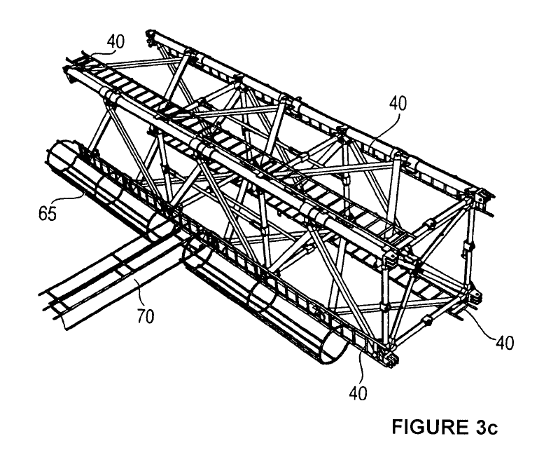

FIG. 3: shows different configurations of the lattice support structure of the invention in the condition folded out.

FIG. 1 shows a lattice support structure in accordance with the present invention in a perspective representation. The same consists of longitudinally extending lattice bars 10, which are arranged such that they form the corners of a rectangle or square of the support structure cross-section. Between these lattice bars 10 struts 50 extend, which have a joint by means of which the struts 50 can be swivelled in and out.

On both sides, these connecting struts are pivotally connected with two lattice bars 10.

Furthermore, connecting lattice bars 20, 30 are provided, which in one end region are each pivotally connected with one of the lattice bars 10 and in the other end region are arranged on a further, preferably adjacent lattice bar 10 via a sliding sleeve 20′, 30′. If the lattice support structure must be folded out from the position shown in FIG. 2, the connecting struts 50 are moved into their position shown in FIG. 1 via the rods 60, which results in the fact that the longitudinally extending lattice bars 10 are moved apart and the lattice support structure is unfolded.

The connecting lattice bars 20, 30 likewise are swivelled, and their sliding sleeves 20′, 30′ are shifted on the lattice bars 10. It is conceivable, for example, to operate the rods 60 by motor, hydraulically, pneumatically or in some other way, in order to effect that the connecting struts 50 are pushed apart.

As can furthermore be taken from FIG. 1 and from FIG. 2, a ladder 40 is arranged on each of the longitudinally extending lattice bars 10, which ladder extends parallel to the longitudinally extending lattice bar 10, i.e. along the entire length thereof.

Rods 65 are pivotally connected with one of the ladders 40, which rods are illustrated in FIG. 1 and FIG. 2 in the condition swivelled against the ladder 40. As can be taken from FIGS. 3b, 3c and 3d, these rods 65 can be swivelled out such that they form a fall arrester for the person standing on the ladder 40. This fall arrester is formed by sector-shaped segments, which are pivotally mounted on the ladder 40 and in turn are connected by rods extending in longitudinal direction and parallel to the ladder 40. In this way, a protection is formed for the person standing on the ladder 40.

It is conceivable that the fall arrester or the rods 65 is/are automatically folded out at the moment when the lattice support structure also is moved from its position folded in as shown in FIG. 2 into its position folded out as shown in FIG. 1.

Reference numeral 70 designates a walkway or step, which likewise is pivotally mounted on the ladder 40, as can for example be taken from FIG. 1 and also from FIG. 2. FIGS. 1 and 2 show the condition of the walkway 70 in the condition swivelled in, in which the walkway extends parallel to the fall arrester or the rods 60 and to the ladder 40.

In the condition of evacuation, the walkway 70 is swivelled out such that it extends horizontally and preferably such that it extends vertical to the lattice support structure and to the ladders 40 and hence also to the longitudinally extending lattice bars 10. This is shown for example in FIG. 3c. By means of the walkway 70, which includes a guard rail, persons can safely get from a building to be evacuated, or the like, to one of the ladders 40 of the lattice support structure and descend via the ladder 40. In the illustrated embodiment, a lattice support structure segment is shown, which includes such walkway 70. In principle, it is likewise conceivable to provide a plurality of such walkways 70 per lattice support structure segment.

FIG. 3a and FIG. 3b show the arrangement of FIG. 3c in a side view and FIG. 3d in a top view.

Apart from the illustrated embodiment, it can furthermore be provided that one fall arrester and/or one walkway each is associated to each or several of the ladders 40.

As can furthermore be taken from FIG. 1 and from FIG. 2, the lattice support structure and/or the illustrated lattice support structure segment is designed to be connected with further identical or differently constructed lattice support structures or support structure elements. Connecting means arranged in the end region of the longitudinally extending lattice bars 10 are used for this purpose. Thus, it is conceivable to connect two or more of the lattice support structures shown in FIGS. 1, 2 and 3 with each other and in this way provide a lattice support structure of the desired height.

It is likewise conceivable to design the lattice support structure segments such that they are telescopable. In this case, a lattice support structure might be incorporated in the interior of the lattice support structure shown in FIG. 1 and be telescoped out, possibly folded out, if necessary and be connected with the illustrated lattice support structure after telescoping out.

This invention, however, is not restricted to telescopable lattice support structures, but also comprises lattice support structures in which the individual segments are attached to each other and then connected with each other before or after folding out, and lattice support structures which only consist of one of the illustrated segments.

1. A lattice support structure which includes interconnected lattice bars (10), wherein the lattice bars are connected with each other such that the lattice support structure can be folded in and out, wherein evacuation means for evacuating persons are arranged on or in the lattice support structure.

2. The lattice support structure according to claim 1, wherein the lattice support structure includes lattice bars (10) extending in longitudinal direction of the lattice support structure and lattice bars (20, 30, 50) directly or indirectly connecting the same, and the connecting lattice bars (20, 30, 50) are connected with the longitudinally extending lattice bars (10) such that the distance of the lattice bars (10) extending in longitudinal direction of the lattice support structure can be reduced when the lattice support structure is folded in and can be increased when the lattice support structure is folded out.

3. The lattice support structure according to claim 1, wherein the evacuation means are formed by at least one ladder (40).

4. The lattice support structure according to claim 3, wherein the at least one ladder (40) is arranged on at least one of the longitudinally extending lattice bars (10) of the lattice support structure.

5. The lattice support structure according to claim 2, wherein a plurality of lattice bars (10) extending in longitudinal direction of the lattice support structure are provided, and on several or all of these lattice bars (10) evacuation means are provided.

6. The lattice support structure according to claim 1, wherein the evacuation means comprise at least one ladder (40) and at least one fall arrester associated to the ladder (40), in particular rods (65) which at least partly surround the space which is taken by a person standing on the ladder (40).

7. The lattice support structure according to claim 1, wherein the evacuation means (70) include at least one walkway (70), which in at least one position protrudes from the lattice support structure or connects different positions of the lattice support structure with each other.

8. The lattice support structure according to claim 7, wherein in at least one position the walkway (70) extends vertically or obliquely from or in the lattice support structure.

9. The lattice support structure according to claim 7, wherein in at least one position the walkway (70) extends parallel to the lattice support structure.

10. The lattice support structure according to claim 1, wherein the connecting lattice bars (20, 30, 50) are located in the outer surface or outer surfaces of the lattice support structure.

11. The lattice support structure according to claim 1, wherein the lattice bars (10) extending in longitudinal direction of the lattice support structure form the outer edges of the lattice support structure.

12. The lattice support structure according to claim 1, wherein the lattice support structure includes a structure of longitudinally extending lattice bars (10) and connecting lattice bars (20, 30, 50), which is repeated in longitudinal direction.

13. The lattice support structure according to claim 1, wherein at least part of the connecting lattice bars (20, 30, 50) are formed by connecting struts (50), which in the condition of the lattice support structure folded out extend vertical to the longitudinal direction of the lattice support structure from one of the lattice bars (10) extending in longitudinal direction of the lattice support structure to the other.

14. The lattice support structure according to claim 13, wherein the connecting struts (50) have at least one joint, by which they can be adjusted between a condition folded in and a condition folded out.

15. The lattice support structure according to claim 1, wherein connecting struts (50) spaced in longitudinal direction of the lattice support structure are connected with each other.

16. The lattice support structure according to claim 1, wherein locking means are provided, by which the connecting lattice bars (10, 20, 50) can be fixed in at least one position.

17. The lattice support structure according to claim 1, wherein means are provided, which act on at least two of the connecting lattice bars (10, 20, 50) and/or of the longitudinally extending lattice bars (10) such that the distance of the lattice bars to each other can be increased or reduced, whereby the lattice support structure is folded in or out.

18. The lattice support structure according to claim 1, wherein the lattice support structure includes at least two support structure segments, which are designed to be telescopable with respect to each other.

19. A lattice support structure with expandable structures, in particular a lattice support structure according to claim 1, wherein the lattice support structure includes pivotally arranged lattice bars, and the pivotable connection is designed such that one of the pivotally connected parts includes a projection and that the other one of the pivotally connected parts includes a groove defined by walls on three sides, in which the projection of the other part is pivotally accommodated.

20. The lattice support structure according to claim 19, wherein the lattice bars include the projection at their one end region and the groove at their other end or that the lattice bars include grooves or projections at both of their end regions.

21. The lattice support structure according to claim 19, wherein a brake means is provided, which fixes the lattice bars in a certain swivel position.

22. The lattice support structure according to claim 21, wherein the brake means is designed as drum or shoe brake.

23. The lattice support structure according to claim 22, wherein the shoe brake is arranged on one of the pivotally connected parts and includes two projections which upon actuation of the brake simultaneously make contact with the other one of the pivotally connected parts.
